(19) United States
(12) Patent Application Publication
(10) Pub. No.: US 2006/0027332 A1
(43) Pub. Date: Feb. 9, 2006

(54) Sticking device and sticking method

(75) Inventor: Akira Dangami, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 11/195,759

(22) Filed: Aug. 3, 2005

(30) Foreign Application Priority Data
Aug. 5, 2004 (JP) 2004-228893

(51) Int. Cl. B65C 9/18

(52) U.S. Cl. 156/541; 156/247; 156/542

(57) ABSTRACT

A sticking device is arranged to be provided with a suction device including a suction surface 25A to suck label L and a driving device rotating and moving the suction device. When the suction surface sucks the label, the right side region of the suction surface faces the upper surface side of the tip of the peel plate. From this state, the driving device rotates the suction device around a rotation axis, and shifts the rotation axis so that the suction surface and the peel plate move away from each other.

### BACKGROUND OF THE INVENTION

1. Field of the Invention

The present invention relates to a sticking device and a sticking method, and more particularly to a sticking device and a sticking method that can prevent interference between a peel plate for peeling off label and a suction surface.

2. Description of the Related Art

Conventionally there has been used a sticking device that can automatically stick label on an object to be stuck that is carried by a transport device such as a belt conveyor, the label being temporarily stuck on one of the surfaces of a strip-shaped release liner (refer to Japanese Patent Publication No. 3370722). The sticking device includes a suction device provided with a suction surface to suck label peeled off by a peel plate on the way of paying out a label base material, and a driving device to shift the suction device towards the side of the object.

Herein, as shown in FIGS. 7 (A) and (B), label L to be peeled off by a peel plate 80, as a release liner S is sharply turned back, tend to be inclined in respect to an upper surface of the peel plate 80. In particular, when the width of the label L along a paying-out direction is short or when the thickness of the label L is thin, the inclination becomes noticeable.

Therefore, as shown in FIG. 8, there is known a sticking device in which a suction device 82 can rotate via a rotation axis 81 so that the direction of a suction surface 82A corresponds to the inclined label L. Hereby, when the label L is sucked on the suction surface 82A, the distance between mating surfaces is shortened so that the label L can be easily sucked on the suction surface 82A. Meanwhile, when the label L is stuck, the label L can be pressed on the upper surface of the object by setting the suction surface 82A to face a substantially horizontal direction.

However, if such label L whose width along a paying-out direction is short or whose thickness is thin, is sucked and held by a device as shown in Japanese Patent Publication No. 3370722, the device has a disadvantage that the label L drop due to the inclination before they have been sucked. Therefore, if the suction device 82 is set inclined as shown in FIG. 8 corresponding to an inclination of the label, and moreover the label L is sucked by positioning the suction device 82 to be as close to the peel plate 80 as possible, a part of the suction surface 82A is positioned above the peel plate 80. As a result, when the suction device 82 is rotated so that the suction surface 82A is moved from an oblique state to a generally horizontal state, the suction surface 82A passes a position very close to the peel plate 80. For this reason, if the position of the peel plate 80 or the suction device 82 deviates even slightly, a disadvantage such as damages may occur due to interference between those devices. Herein, if the distance between the suction surface 82A and the peel plate 80 is arranged to be large enough, the interference can be avoided, raising instead another disadvantage of reduction in suction force given to the label L peeled off.

As described above, the structure in FIG. 8 has such a disadvantage that a complicated operation for locating the peel plate 80 and the suction device 82 with high accuracy is inevitable in order to make the suction force work properly, while avoiding the interference between the peel plate 80 and the suction device 82.

### SUMMARY OF THE INVENTION

The present invention has been proposed from a viewpoint of the foregoing disadvantages and an object of the present invention is to provide a sticking device and a sticking method that can reliably suck label on a suction surface, and also can easily avoid interference between a peel plate and a suction device.

In order to achieve the object, the present invention is arranged in such a manner that a sticking device to stick label peeled off sequentially via a peel plate on a predetermined object to be stuck on the way of paying out a label base material where labels are temporarily stuck on one of the surfaces of a strip-shaped release liner, comprising:
a suction device including a suction surface to suck the label peeled off from the peel plate at a position facing the peel plate; and
a driving device to move relatively the suction device and the peel plate, wherein
the driving device rotates relatively the suction device and the peel plate, and meanwhile, shifts a central position of the rotation so that the suction surface and the peel plate move away from each other.

In the present invention, it is preferable that a part of the suction surface is positioned in an upper surface side of a tip of the peel plate at a sucking position in sucking the label peeled off.

The present invention can be also arranged in such a manner that the suction device can be rotated by the driving device and a pressing roller is disposed at a position in the vicinity of the suction surface; wherein, after the pressing roller sticks the label sucked on the suction surface on the object, the pressing roller is arranged to roll on the label stuck on the object by the rotation of the suction device.

Moreover, the present invention is arranged in such a manner that a sticking method of sticking label peeled off sequentially via a peel plate on a predetermined object to be stuck on the way of paying out a label base material where labels are temporarily stuck on one of the surfaces of a strip-shaped release liner, comprising the steps of:
positioning a suction surface of a suction device at a position facing the peel plate;
sucking the label peeled off from the peel plate by the suction surface;
relatively rotating the suction device and the peel plate around a central position of a predetermined rotation axis; and
sticking the label on the object by shifting the rotation axis so that the suction surface and the peel plate move away from each other.

According to the present invention, as compared to a case in which the suction device and the peel plate are rotated only relatively from a position where the peel plate and the suction surface face each other, the distance between the peel plate and the suction surface can be allowed at the time of the relative rotation. That is, the distance between the suction surface and the label to be peeled off can be set to be shortened at the time when the peel plate and the suction surface face each other, and on the other hand, the distance between the peel plate and the suction surface is set to be long at the time of the relative rotation. Consequently the label can be securely sucked by the suction surface immediately after the label is peeled off from the release liner, and high-accurate and complicated operations for positioning to prevent interference between the peel plate and the suction surface can be avoided. In particular, in a case a part of the suction surface is positioned at the upper surface side of the tip of the peel plate, the direction of the suction surface can be set corresponding to the label to be peeled off.

In addition, since the pressing roller, which rolls on the label stuck on the object, is disposed, the label can be stuck more properly with not only suction force given by the suction surface, but also pressure of the pressing roller. Furthermore, since the pressing roller is rolled by rotation of the suction device, pressing force can be provided by the pressing roller without transferring the object by a belt conveyor or the like.

### BRIEF DESCRIPTION OF THE DRAWINGS

FIG. 1 is a schematic front view showing a sticking device according to a preferred embodiment of the present invention;

FIG. 2 is an enlarged view showing a main part of FIG. 1;

FIG. 3 is a left side view of FIG. 2;

FIG. 4 is a front view showing the sticking device same as in FIG. 1 in a state where a suction surface is set as a sucking position;

FIG. 5 is a front view showing the sticking device same as in FIG. 1 in sticking label on the suction surface;

FIG. 6 is a front view showing the sticking device same as in FIG. 1 in pressing the label with the pressing roller;

FIG. 7(A) and FIG. 7(B) are explanatory views showing a state of label on the peel plate; and

FIG. 8 is a diagrammatic sketch of a suction device according to the related art.

### DETAILED DESCRIPTION OF THE PREFERRED EMBODIMENT

A preferred embodiment of the present invention will be explained hereinafter with reference to the drawings.

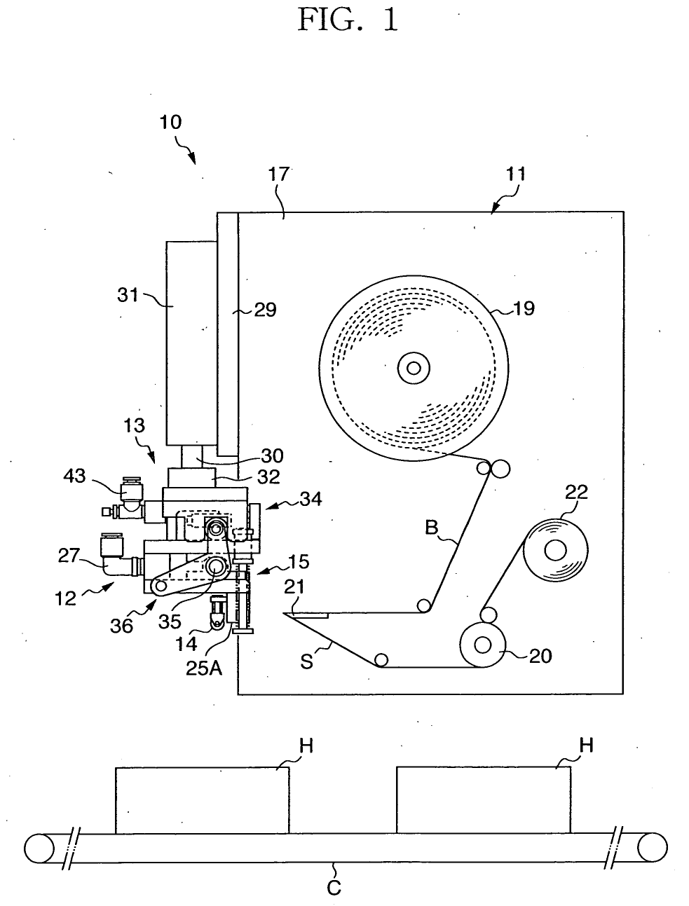

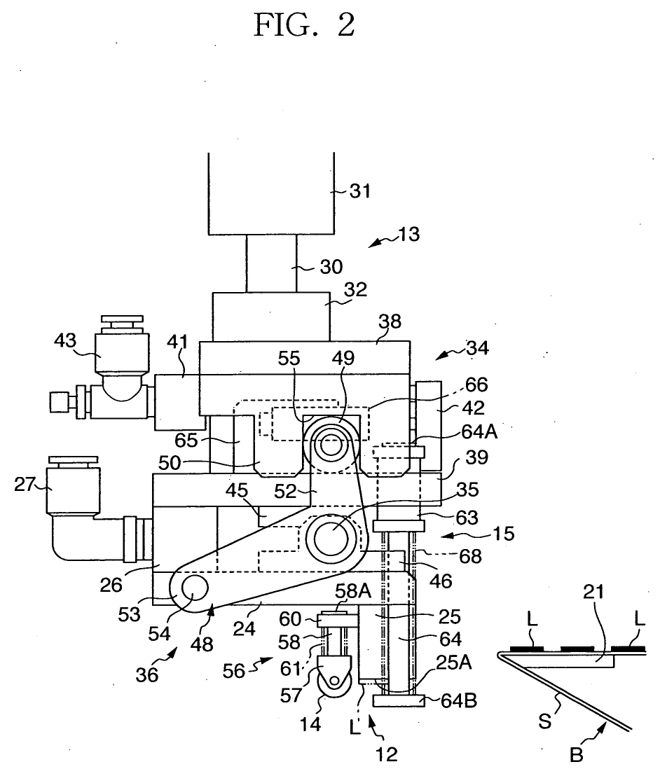

Note that directional or positional terms used in the detailed description, unless clearly specified otherwise, are defined based on FIG. 1 and FIG. 2.

In FIG. 1, a schematic front view of a sticking device according to the preferred embodiment is shown, and in FIG. 2, an enlarged front view of a main part of FIG. 1 is shown. In these figures, a sticking device 10 includes a label provider 11 located above a belt conveyor C that can transport the objects to be stuck H, a suction device 12 that sucks label L provided by the label provider 11, a driving device 13 that drives the suction device 12, a pressing roller 14 disposed on the left side of the suction device 12, and a detector 15 disposed in the vicinity of the suction device 12.

The label provider 11 comprises broadly: a frame board 17; a paying-out reel 19 that is rotatably supported within the surface of the frame board 17 and pays out a label base material B composed of a strip-shaped release liner S, on one of surfaces of which labels L are temporarily stuck by a predetermined pitch; a paying-out roller 20 that is supported within the surface of the frame board 17 and gives paying-out force to the label base material B, the roller 20 being connected to a motor (not shown); a peel plate 21, which is positioned so that the tip thereof directs towards the suction device 12 in substantially horizontal direction and also turns back the release liner S between the paying-out roller 20 and the paying-out reel 19; and a winding reel 22 that winds the release liner S after the label L is peeled off.

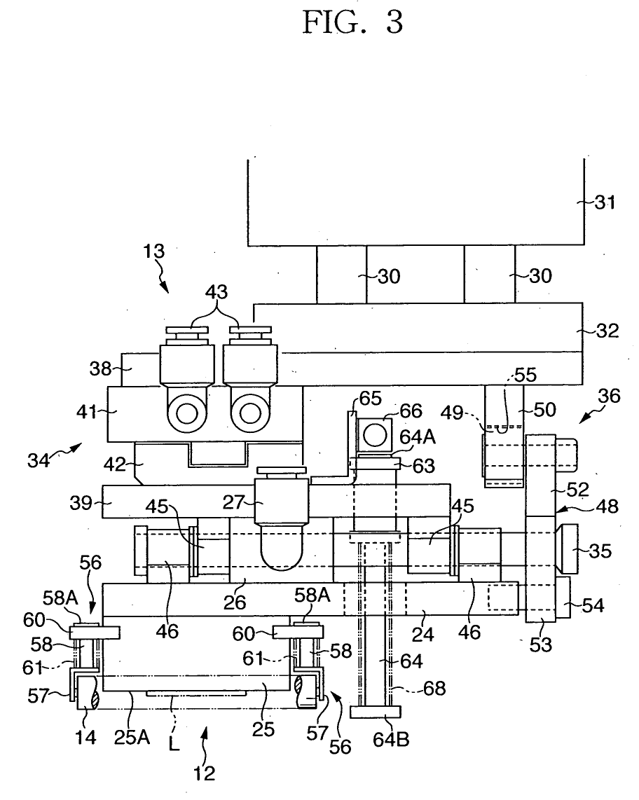

The suction device 12, as shown in FIG. 2 and FIG. 3, includes: a base body 24 shaped in a substantially square plate; a suction grid 25 that is disposed under a lower surface side of the base body 24 in the right side in FIG. 2 and in the left side in FIG. 3 and the lower face of the grid 25 forms a suction surface 25A; and a suction pipe holder 27 connected to the left side of an upper face side of the base body 24 through a block body 26. A hose attached to a suction pump (not shown) is connected to the suction pipe holder 27. In the base body 24 and the block body 26, a passageway (not shown) communicated with the suction pipe holder 27 and the suction grid 25 is formed. Hereby, sucking is performed from the suction surface 25A by operating the suction pump to suck and hold the label L on the suction surface 25A.

The driving device 13, as shown in FIG. 1, is supported by an attachment plate 29 disposed in the left side of the frame board 17. The driving device 13, as shown in FIG. 2 and FIG. 3, is attached to the attachment board 29 and includes: a cylinder 31 that is provided with, at the side of the lower end, two rods 30, 30 (refer to FIG. 3) moving vertically; a connection board 32 that connects the each lower end of the rods 30, 30; a slider 34 disposed in a lower surface side of the connection board 32; a rotation axis 35 located between the slider 34 and the suction device 12; and a direction switcher 36 disposed at an end side of the rotation axis 35, that is, in a right end side in FIG. 3.

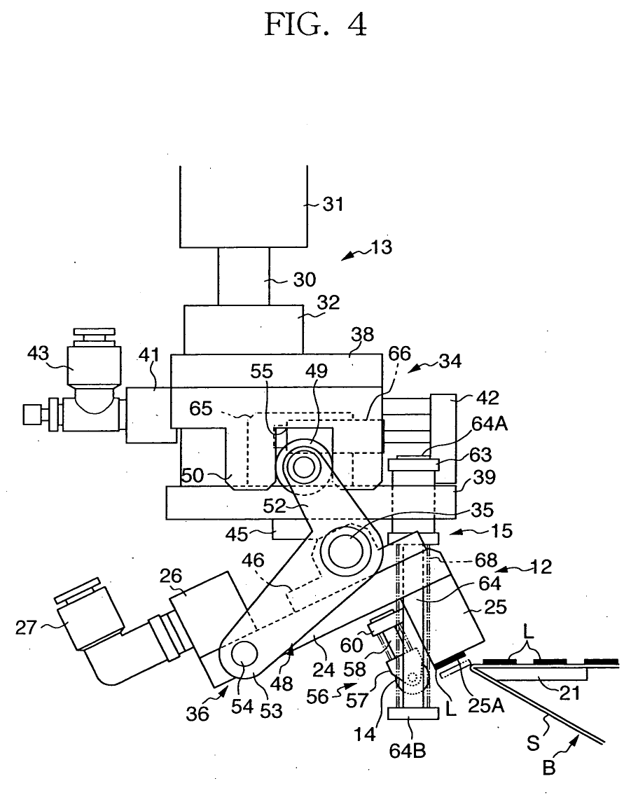

The slider 34 includes: an upper table 38 fixed to a lower face of the connection board 32; a lower table 39 disposed under the upper table 38 and positioned substantially in parallel with the upper table 38; a sliding body 41 attached to a lower face of the upper table 38; and a sliding table 42 attached to an upper face of the lower table 39 and combined with the sliding body 41. As shown in FIG. 3, a pair of hose holders 43, 43 are attached to the sliding body 41 and hoses connected to a pump (not shown) are respectively attached to each of the hose holders 43, 43. By supplying compressed air into one of the hose holders 43, the sliding table 42 moves relatively, which shifts the lower table 39 in the right direction relative to the upper table 38 (refer to FIG. 4). At this state, if the compressed air is supplied into the other hose holder 43, the first and second sliding bodies 41, 42 move in a direction opposite to the direction described above, which shifts the lower table 39 in the left direction in FIG. 4 relative to the upper table 38.

The rotation axis 35 extends in a substantially horizontal direction, that is, the right and left directions in FIG. 3, and is disposed between the base body 24 of the suction device 12 and the lower table 39. The rotation axis 35 is rotatably supported by a pair of bearings 45, 45 disposed in the lower face of the lower table 39 and a pair of bearings 46, 46 disposed in the upper face of the base body 24. Therefore it becomes possible that the suction device 12 rotates relatively around the center of the rotation axis 35 in respect of the lower table 39.

The direction switcher 36 includes: an arm 48, formed in an L-shape when viewed from front and connected rotatably to one end side of the rotation axis 35; a roller 49 disposed in the upper side of the arm 48; and a guide 50 that controls movement of the roller 49.

The arm 48 includes: a vertical segment 52 extending upwards from the rotation axis 35; and an oblique segment 53 connected to a lower end of the vertical segment 52 extending downwards in inclined direction. And the arm 48 is arranged to rotate around the center of the rotation axis 35. A supporting axis 54 connected to the right end side of the base body 24 in FIG. 3 penetrates through the lower region of the oblique segment 53.

The roller 49 is rotatably connected to the upper side of the vertical segment 52. And the guide 50 is formed in a plate material hanging down from the lower face of the upper table 38 of the slider 34. The guide 50 is formed in a concave shape opened downwards when viewed from front, including a fitting part 55 to fit the roller 49, and guides the vertical shifts of the roller 49, while restricting the movement thereof in the right and left directions inside the fitting part 55.

The pressing roller 14 stretches substantially in parallel with the rotation axis 35 (refer to FIG. 1) and, as shown in FIG. 3, is supported on the left side of the suction grid 25 via a pair of supporters 56, 56, provided respectively in each end of both sides. The supporter 56 includes: a bracket 57 that supports rotatably an end side of the pressing roller 14; an axis member 58 extending upwards from the bracket 57 provided with a flange 58A formed on the upper end; a plate-shaped section 60 attached to the suction grid 25 having the axis member 58 therethrough and having the flange 58A seated on the upper face; and a coil spring 61 that is disposed between the plate-shaped section 60 and the bracket 57 through which the axis member 58 penetrates. The axis member 58 is disposed in a vertically movable manner in FIG. 2 in a state where the axis member 58 is arranged to pass through the plate-shaped section 60, which enables the pressing roller 14 to shift vertically. Besides, the coil spring 61 is arranged to provide constantly elastic force against the bracket 57 and the pressing roller 14 to urge them downwards.

The detector 15 includes: a cylindrical body 63 that is attached to the lower table 39 to be directed upwards and downwards; a shaft 64 that can slide vertically in a state being inserted in the cylindrical body 63; and a sensor 66 that is disposed on an upper face side of the lower table 39 via an angle member 65 and can detect an upper end of the shaft 64. An upper flange 64A seated on the upper end surface of the cylindrical body 63 is connected to an upper end side of the shaft 64. A lower flange 64B positioned below the suction surface 25A is connected to a lower end side of the shaft 64. A coil spring 68 through which the shaft 64 penetrates is disposed between the lower flange 64B and the lower end surface of the cylindrical body 63. The coil spring 68 provides constantly elastic force to urge the shaft 64 downwards.

Note that a motor driving the paying-out roller 20, suction grid 25 and each of the pumps performing sucking through the slider 34, the cylinder 31, the sensor 66 and the like are integrally controlled by a control means (not shown).

Operations of the suction device 12 will be hereinafter described with reference to FIG. 2 and FIG. 4.

In order to drive the suction device 12 to shift from the state in FIG. 2 to that in FIG. 4, only one thing to do is to shift the lower table 39 to the right direction relative to the upper table 38 by supplying compressed air into the slider 34. Hereby, the rotation axis 35 shifts to the right direction accompanied with the shift of the lower table 39, and since the horizontal movement of the roller 49 is restricted by the guide 50, the rotation axis 35 moves away to the right direction from a position right under the roller 49, and hence the arm 48 rotates in the counterclockwise direction around the rotation axis 35 while the roller 49 descends in the guide. Then, since the suction device 12 is supported by the arm 48 via the supporting axis 54 and the rotation axis 35, the suction device 12 as well as the arm 48 rotates in the counterclockwise around the rotation axis 35. At the time of the rotation, since the rotation axis 35 shifts to the right direction, the suction device 12 also shifts to the right direction. As a result, the suction device 12, while rotating around the rotation axis 35, moves along the trace where the rotation center shifts to the right direction.

On the other hand, in order to drive the suction device 12 from the state in FIG. 4 to that in FIG. 2, the lower table 39 is shifted in the left direction relative to the upper table 38. Hereby the rotation axis 35, the roller 49, and the arm 48 shift in the opposite direction, and therefore, the suction device 12 moves in the opposite direction along the same trace as stated above. As a result, when the suction device 12 is rotated from a position shown in FIG. 4 in which the right side region of the suction surface 25A faces the upper surface side of the tip of the peel plate 21 to a position shown in FIG. 2, the suction device 12 and the peel plate 21 rotate relatively around the rotation axis 35, whereby the rotation axis 35 shifts in the left direction so that the suction surface 25A moves away from the peel plate 21.

Next the sticking process of label L by the sticking device 10 will be described with reference to FIG. 2, and FIG. 4 to FIG. 6.

It is assumed that the suction device 12 is arranged in a sucking position shown in FIG. 4, namely, in such a manner that the suction surface 25A is inclined in the upper-right direction in accordance with the inclination of the label L to be peeled off, and the object H on the belt conveyer C is at a standstill under the suction device 12.

In this state, on the way of paying out the label base material B, the label L reaches the position shown in FIG. 4, by a chain double-dashed line, and the label L is peeled off by turning back the release liner S by the peel plate 21, and then the label L is sucked and held by the suction surface 25A. After that, by operating the slider 34, the suction device 12 is moved to the position shown in FIG. 2, thus directing the suction surface 25A in a substantially horizontal direction.

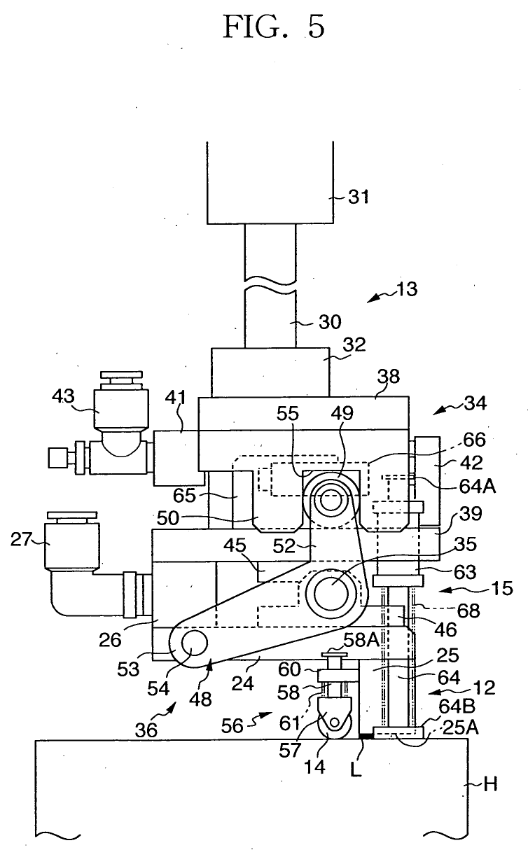

Next, as shown in FIG. 5, the suction device 12 descends by the rod 30 of the cylinder 31, and presses the label L sucked on the suction surface 25A on the upper surface of the object H. At this time, the pressing roller 14 presses the upper surface of the object H by elastic force of the coil spring 61, and also the shaft 64 elevates within the cylindrical body 63 against elastic force of the coil spring 68. When the sensor 66 detects the upper end side of the shaft 64, the sensor 66 outputs a signal to stop the cylinder 31, whereby pressure from the suction surface 25A to the object H is adjusted appropriately and the label L is stuck on the object H, and then sucking of the label L by the suction surface 25A is released.

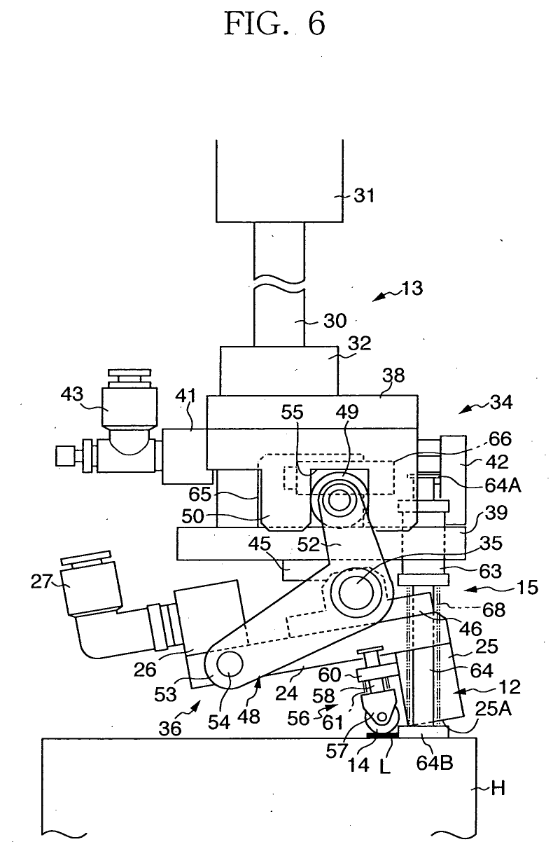

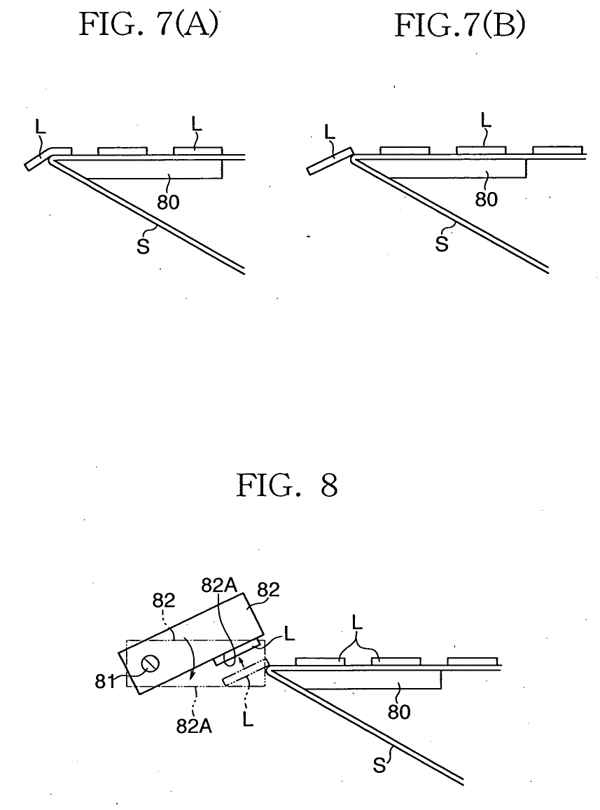

When the suction device 12 is moved by the slider 34 from this state to a state shown in FIG. 6, the roller 14 shifts to the right direction and rolls on the label L stuck on the object H. At this time, since the pressing roller 14 is urged downwards by the coil spring 61, additional pressing force is given to the label L by the pressing roller 14.

According to the embodiment stated so far, the pressing force can be provided to the label L through two steps, a first one is the suction surface 25A to be descended by the cylinder 31, and a second one is rolling of the pressing roller 14, which enables the label L to be stuck on the object H properly.

Besides, since the suction device 12 moves along the trace described above, even if the suction surface 25A is inclined in respect to the upper side of the peel plate 21 and the label L is sucked in a state where the suction surface 25A is positioned to be close to the label L, the suction surface 25A moves so as to keep away from the tip of the peel plate 21. Hereby, it is possible to eliminate the necessity of high-accurately positioning the suction device 12 or the like in order to avoid interference between the peel plate 21 and the suction surface 25A.

The best arrangement and method to carry out the present invention are disclosed in the description stated above, but the present invention is not limited to the above.

Namely, the present invention particularly illustrates and describes a specific preferred embodiment, but it is apparent to those skilled in the art that various modifications in shapes, amounts, other detailed arrangements to the described preferred embodiment within the scope of the technical concept and object of the present invention are made.

Accordingly the description specifying the configuration or the like is exemplarily made for the purpose of facilitating understanding of the present invention and does not limit the scope of the present invention. Accordingly, any descriptions using names of the components excluding a part of or an entirety of limitations in these shapes or the like are to be included in the present invention.

For instance, in the preferred embodiment described above, the suction device 12 is rotated and moved, but not limited to this, the suction device 12 and the peel plate 21 may perform relative rotation by rotating the peel plate 21. However, rotation of the suction device 12 causes the advantage that the pressing roller 14 can roll on the label L by the rotation of the suction device 12.

The present invention is applied to a sticking device and a sticking method in which label is stuck on a plurality of the objects transported sequentially.

1. A sticking device to stick label peeled off sequentially via a peel plate on a predetermined object to be stuck on the way of paying out a label base material where labels are temporarily stuck on one of the surfaces of a strip-shaped release liner, comprising:
a suction device including a suction surface to suck the label peeled off from said peel plate at a position facing said peel plate; and
a driving device to move relatively said suction device and said peel plate, wherein
said driving device rotates relatively said suction device and said peel plate, and meanwhile shifts a central position of the rotation so that the suction surface and said peel plate move away from each other.

2. The sticking device according to claim 1, wherein:
a part of said suction surface is positioned in an upper surface side of a tip of said peel plate at a sucking position in sucking the label peeled off.

3. The sticking device according to claim 1 or 2, wherein
said suction device can be rotated by said driving device; and
a pressing roller is disposed at a position in the vicinity of the suction surface, and wherein after said pressing roller sticks the label sucked on the suction surface on the object, said pressing roller is arranged to roll on the label stuck on the object by the rotation of said suction device.

4. A sticking method of sticking labels peeled off sequentially via a peel plate on a predetermined object to be stuck on the way of paying out a label base material where labels are temporarily stuck on one of the surfaces of a strip-shaped release liner, comprising the steps of:
positioning a suction surface of a suction device at a position facing said peel plate;
sucking the label peeled off from said peel plate by the suction surface;
relatively rotating said suction device and said peel plate around a central position of a predetermined rotation axis; and
sticking the label on the object by shifting the rotation axis so that the suction surface and said peel plate move away from each other.
